(19) United States
(12) Patent Application Publication
(10) Pub. No.: US 2026/0177082 A1
(43) Pub. Date: Jun. 25, 2026

(54) HYDRAULIC BLOCKING ROTARY ACTUATOR WITH CONTINUOUS SEAL EXTENDING TO RADIAL LOCATIONS

(71) Applicant: Woodward, Inc., Fort Collins, CO (US)

(72) Inventor: Jiahua Lu, Monterey Park, CA (US)

(73) Assignee: Woodward, Inc., Fort Collins, CO (US)

(21) Appl. No.: 18/990,905

(22) Filed: Dec. 20, 2024

(51) Int. Cl. F16J 15/54

(52) U.S. Cl. CPC F15B 15/12; F16J 15/545

(57) ABSTRACT

A rotary actuator includes a rotor in which a well is formed and a static rotary piston having an inner vane extending into the well. A seal groove and a seal runs along a peripheral face of the inner vane and lateral and longitudinal ends of the static rotary piston. The continuous seal contacts the rotor to form a vane seal transition from a face seal located at the inner vane surface perpendicular to a rotary axis of the rotor to a radial seal located at the lateral end of the interior wall of the static rotary piston in parallel with the rotary axis. Such seal divides the well into two pressure chambers and is configured as a dynamic seal to prevent leakage between them. The radial seal eliminates an interior seal gland wall, allowing for a taller rotor vane and increased rotary torque for a given outside diameter.

### FIELD OF THE INVENTION

This invention generally relates to hydraulic blocking rotary actuators, and more particularly to sealing arrangements for hydraulic blocking rotary actuators and hydraulic blocking rotary actuators having same.

### BACKGROUND OF THE INVENTION

Hydraulic blocking rotary actuators that are used to control the positioning of aircraft flight control surfaces, rotary valve assemblies, and other components on modern aircraft are well known for their ability to maintain constant torque for holding the position of the controlled surface, valve, etc. by simply blocking the hydraulic power source without the need to supply additional make up fluid and constant control.

One such hydraulic blocking rotary actuator is described in U.S. Pat. No. 8,915,176 B2, entitled HYDRAULIC BLOCKING ROTARY ACTUATOR, and assigned to the assignee of the instant application, the teachings and disclosure of which are hereby incorporated herein in their entireties for all purposes.

As may be seen in FIG. 7, a rotary actuator insert assembly 400 includes the rotor 402 and static rotary piston 404, 406. The inner vane 408 extends an inward distance from the interior wall 410 such that sections of the continuous seals 412, resting in the continuous seal grooves 414, will be brought into sealing contact with a first diameter 416 of the rotor 402. The outer vanes 418 extend an inward distance from the interior wall 410 such that sections of the continuous seals 412, resting in the continuous seal grooves 414, will be brought into sealing contact with a second diameter 420 of the rotor 402. A portion of the continuous seals 412 disposed in the continuous seal grooves 414 on the lateral face of static pistons 404, 406 are in sealing contact with interior lateral surfaces of the end sections 422. When assembled, the rotor 402, the static pistons 404, 406, and the continuous seals 412 form four fluid pressure chambers.

As shown in FIG. 8, which is a side cross-sectional view of the rotary actuator including the insert assembly just discussed, the rotor 402 and the static pistons 404, 406 are shown assembled with a housing 502. In general, the continuous seals 412 are placed in the continuous seal grooves, and the static pistons 404, 406 are assembled into the rotor 402 between the end sections 422. The assemblage of the static pistons 404, 406 and the rotor 402 is then inserted into the housing 502 through one of the housing ends 508, 510, and is retained axially by the bushing assemblies 504, 506.

FIG. 9 shows a cross-sectional view of the rotary actuator 500 an operational position in which the rotor 402 encounters a substantially clockwise rotational limit. This substantially clockwise rotation limit is reached when fluid is applied to the pressure chambers 602, 604 as known in the art. In some implementations, the rotor 402 can be held in substantially any rotational position by blocking the fluid source, e.g., by a flow control valve in the hydraulic circuit in some embodiments. The continuous seals 412 block the cross fluid chamber leakage. Such sealing of the fluid chambers by the continuous seals 412 provides a significant advantage over non-blocking-type rotary actuators that require make up fluid to be supplied to hold rotational position due to leakage.

Unfortunately, the physical size and configuration of these continuous seals 412 has limited the angular torque output and stroke of the rotor 402. The angular torque output is limited because the face sealing portions of the continuous seals along the end sections 422 have a face seal width W_{FS} shown in FIG. 10 that, when the thickness of the and gland walls are included, dictate a minimum stator radial thickness S_{RT}. This required minimum stator radial thickness S_{RT} then constrains the maximum stator vane length SV_{L}, which in turn limits the rotor vane length RV_{L}. Because the angular torque is partly a function of the rotor vane length RV_{L}, the limitation on this parameter reduces the angular torque available for a given diameter rotary actuator.

The stroke of the rotor 402 is likewise limited because the stator vane width SV_{W} of the two vane sealing portions of the continuous seals 412 along the inner vanes 408 along with their gland walls reduces the available angular width between such stator vanes 408 through which the rotor vanes can stroke. This also imposes a limit on the maximum width of the seal 412 cross section, especially where the seal width to seal thickness ratio is larger than one, and thus the sealing capability of the continuous seals.

What is needed, therefore, is a continuous sealing arrangement for a hydraulic blocking rotary actuator that reduces the required minimum stator radial thickness to allow an increase in maximum rotor vane outside diameter, and therefore an increase in the angular torque output and stroke of the rotor for a given outside diameter of the rotary actuator. Embodiments of the present invention provide such a sealing arrangement and hydraulic blocking rotary actuators utilizing same. These and other advantages of the invention, as well as additional inventive features, will be apparent from the description of the invention provided herein.

### BRIEF SUMMARY OF THE INVENTION

In view of the above, embodiments of the present invention provide a new and useful hydraulic blocking rotary actuator that address one or more of the above-described issues. More particularly, embodiments of the present invention provide a new and improved hydraulic blocking rotary actuator that includes a vane seal transition from a face seal located at an inner vane surface perpendicular to a rotary axis of the rotor to a radial seal located at the lateral end of an interior wall of a static rotary piston in parallel with the rotary axis of the rotor. Beneficially, the radial seal of the vane seal transition eliminates the need for an interior seal gland wall, thereby allowing for a thinner static rotary piston. This allows for the use of taller rotor vanes that provide higher rotary torque for the same outside diameter of the rotary actuator.

In one embodiment, a rotary actuator includes a rotor in which a well is formed and a static rotary piston having an inner vane extending into the well. A seal groove and a seal runs along a peripheral face of the inner vane and lateral and longitudinal ends of the static rotary piston. The continuous seal contacts the rotor to form a vane seal transition from a face seal located at the inner vane surface perpendicular to a rotary axis of the rotor to a radial seal located at the lateral end of the interior wall of the static rotary piston in parallel with the rotary axis. Such seal divides the well into two pressure chambers and is configured as a dynamic seal to prevent leakage between them. The radial seal eliminates an interior seal gland wall, allowing for a taller rotor vane and increased rotary torque for a given outside diameter.

In another embodiment, a rotary actuator includes a rotor having a first diameter portion forming a well within a second diameter portion. A static rotary piston includes an inner vane extending an inward radial distance from an interior wall and extends into the well formed by the first diameter portion of the rotor. The static rotary piston defines a seal groove that runs along a peripheral face of the inner vane and lateral and longitudinal ends of the interior surface of the static rotary piston. A continuous seal is configured to seat in the seal groove. Preferably, the continuous seal is in sealing contact with the rotor such that the continuous seal forms a vane seal transition from a face seal located at the inner vane surface perpendicular to a rotary axis of the rotor to a radial seal located at the lateral end of the interior wall of the static rotary piston in parallel with the rotary axis of the rotor thereby dividing the well into a first and a second pressure chamber. The continuous seal is configured as a dynamic seal to prevent leakage between the first and second pressure chambers.

In another embodiment, the static rotary piston includes a first static rotary piston and a second static rotary piston each formed as a half-cylinder shell. Preferably, the rotor has two first diameter portions forming a first and a second well opposite one another within the second diameter portion. The first static rotary piston and the second static rotary piston each have an inner vane extending an inward radial distance from an interior wall that extends into an associated well of the rotor. Each of the first static rotary piston and the second static rotary piston have a continuous seal in sealing contact with the rotor such that each of the continuous seals form a vane seal transition from the face seal located at the inner vane surface perpendicular to the rotary axis of the rotor to the radial seal located at the lateral end of the interior wall of the static rotary piston in parallel with the rotary axis of the rotor thereby dividing the first well into a first and a second pressure chamber and the second well into a third and fourth pressure chamber.

In one embodiment the second pressure chamber and the third pressure chamber are in fluid communication to rotate the rotor in a first direction when fluid pressure is supplied thereto, and the first pressure chamber and the fourth pressure chamber are in fluid communication to rotate the rotor in a second direction when fluid pressure is supplied thereto. In an embodiment, the first pressure chamber and the fourth pressure chamber are in fluid communication via a connecting passage through the rotor, and wherein the second pressure chamber and the third pressure chamber are in fluid communication via an exterior of the rotor.

In an embodiment the seal groove includes a first seal groove that runs along a peripheral face of the inner vane and along a first half of the lateral and the longitudinal ends of the interior surface of the static rotary piston, and a second seal groove that runs along the peripheral face of the inner vane and along a second half of the lateral and the longitudinal ends of the interior surface of the static rotary piston. Preferably, the continuous seal includes a first continuous seal configured to seat in the first seal groove and a second continuous seal configured to seat in the second seal groove.

In another embodiment, the radial seal of the vane seal transition does not include an interior seal gland wall. Such vane seal transition allows thinner static pistons, which allows a taller shaft vane and thus more pressurized area with longer moment arm for higher torque output with the same outside diameter of the rotary actuator. In an embodiment the seal cross-section width is replaced with a lower seal cross-section height. The seal cross section width (W_{CS}) is increased in an embodiment along the axis of shaft rotation to increase the sealing surface contact and better sealing capability without affecting the static pistons' thickness or reducing the torque output.

In another embodiment, the continuous seal fluidly isolates the first pressure chamber from the second pressure chamber. Preferably, the rotor is fluidly sealed within a housing by dynamic seals, static seals and positioned therein by bearings and retainers, and the second pressure chamber is in fluid communication with an exterior of the rotor and sealingly isolated by the dynamic seals, static seals, bearings, and retainers.

In another embodiment the static rotary piston includes a first static rotary piston, a second static rotary piston, and a third static rotary piston, and the rotor has three first diameter portions forming a first, a second, and a third well formed about the rotor within the second diameter portion. The first static rotary piston, the second static rotary piston, and the third static rotary piston each have an inner vane extending an inward radial distance from an interior wall that extends into an associated well of the rotor. Each of the first static rotary piston, the second static rotary piston, and the third static rotary piston have a continuous seal in sealing contact with the rotor such that each of the continuous seals form a vane seal transition from the face seal located at the inner vane surface perpendicular to the rotary axis of the rotor to the radial seal located at the lateral end of the interior wall of the static rotary piston in parallel with the rotary axis of the rotor thereby dividing the first well into a first and a second pressure chamber, the second well into a third and fourth pressure chamber, and the third well into a fifth and sixth pressure chamber.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is an exploded view of an embodiment of a rotary actuator insert assembly of a rotary actuator constructed in accordance with the teachings of the present invention;

FIG. 2 is a side cross-sectional view of an embodiment of a rotary actuator having the rotary actuator insert of FIG. 1 installed therein;

FIG. 3 is a cross-sectional view of the embodiment of the rotary actuator of FIG. 2;

FIG. 4 is an exploded view of an alternate embodiment of a rotary actuator insert assembly of a rotary actuator constructed in accordance with the teachings of the present invention;

FIG. 5 is a side cross-sectional view of an embodiment of a rotary actuator having the rotary actuator insert of FIG. 4 installed therein;

FIG. 6 is a cross-sectional view of the embodiment of the rotary actuator of FIG. 5;

FIG. 7 is an exploded view of a prior art rotary actuator insert assembly of a rotary actuator;

FIG. 8 is a side cross-sectional view of a prior art rotary actuator having the rotary actuator insert of FIG. 7 installed therein;

FIG. 9 is a cross-sectional view of the prior art rotary actuator of FIG. 8; and

FIG. 10 is a partial cross-sectional view of the prior art rotary actuator of FIG. 8 illustrating physical constraints imposed by the continuous seals used therein.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, there are illustrated embodiments of hydraulic blocking rotary actuators and sealing arrangements used therein that are constructed in accordance with the teachings of the present invention. However, while the following description will describe various aspects of such embodiments that are particularly well suited for applications that require the positioning and holding of aircraft flight control surfaces, rotary valve assemblies, and other components on modern aircraft, the invention is not so limited. Indeed, such embodiments and applications should be taken by way of example and not by way of limitation.

With reference to the exploded view of FIG. 1, an improved hydraulic blocking rotary actuator 100 having continuous seals 102A, 102B, 102c, and 102p that are extended to radial locations 108 on the end sections 104 of the rotor 106 is illustrated. The rotary actuator insert assembly 110 of the rotary actuator 100 includes the rotor 106 and static rotary pistons 112, 114 that are housed in housing 128.

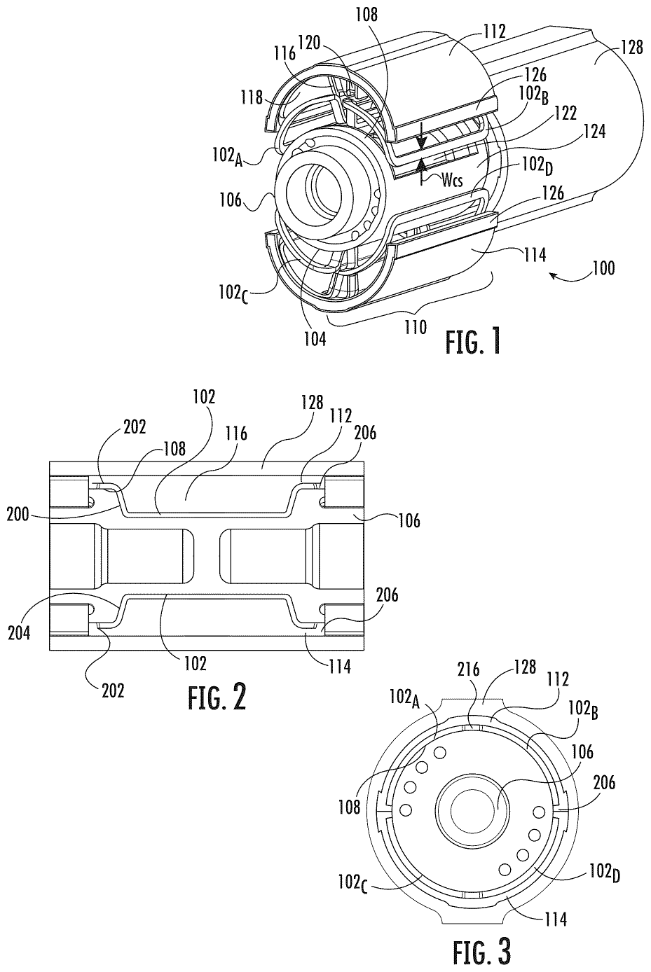

The inner vane 116 of the static rotary pistons 112, 114 extends an inward distance from the interior wall 118 such that sections of the continuous seals 102, resting in the continuous seal grooves 120, will be brought into sealing contact with a first diameter portion 122 that forms a well in the rotor 106. As best seen in FIGS. 2 and 3, outer vanes 206 that extend an inward distance from the interior wall 118 of the static rotary pistons 112, 114 to position sections of the continuous seals 102 into sealing contact with a second diameter 124 surrounding the wells of the rotor 106. A portion of the continuous seals 102 that run parallel to the axis of rotation at the ends 126 of the static rotary pistons 112, 114 contacts the second diameter 124 of the rotor, forming a face seal thereon.

A portion of the continuous seals 102 that run perpendicular to the axis of rotation of the rotor 106 on the lateral end of the interior wall 118 of static pistons 112, 114 are in sealing contact with the outer radial locations 108 on the end sections 104 of the rotor 106. When assembled, the rotor 106, the static pistons 116, and the continuous seals 102 form four fluid pressure chambers.

Advantageously, the configuration of the continuous seals 102 of an embodiment of the present invention changes the vane seal transition from a face seal 200 (see FIG. 2) located at the inner vane 116 surface perpendicular to the rotary axis to a radial seal 202 (see also FIG. 2) located at the lateral end of the interior wall 118 of the static rotary piston 112, 114 in parallel with the rotary axis. The transition and radial seal is in contact with the rotor shaft radial surface 108 and works as a dynamic seal.

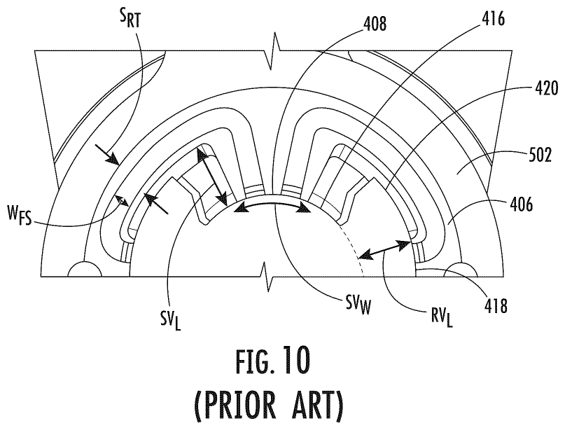

This change of vane seal transition allows a thinner stator (static pistons 112, 114) design by eliminating the need of one of the seal gland walls discussed above with regard to FIG. 10 and replacing the usually wider seal cross-section width with a lower seal cross-section height. The thinner static pistons 112, 114 allow a taller shaft vane and thus more pressurized area with longer moment arm for higher torque output with the same outside diameter of the rotary actuator 100. The seal cross section width (W_{CS}) can be increased along the axis of shaft rotation to increase the sealing surface contact and better sealing capability without affecting the static pistons' 112, 114 thickness or reducing the torque output.

In view of the above, those skilled in the art will appreciate that the two continuous seal pairs 102A/102B and 102c/102D for each or either of the static rotary pistons 112, 114 can be formed as a single seal. In such embodiment, the two seal grooves defined in the inner vane discussed above are combined into a single seal groove that then connects to a single seal groove formed in the interior wall.

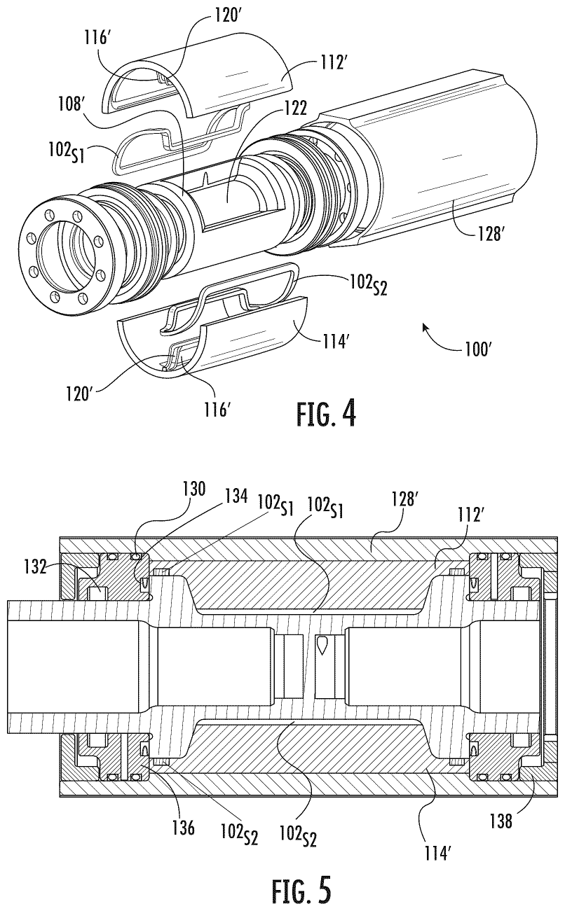

One such embodiment using a single seal may be seen with reference to the exploded view of FIG. 4. This embodiment of an improved hydraulic blocking rotary actuator 100′ has continuous seals 102s1 and 102s2 that are extended to radial locations 108′ on the end sections of the rotor is illustrated. As with the prior embodiment, static rotary pistons 112′, 114′ are housed in housing 128′.

The inner vane 116′ of the static rotary pistons 112′, 114′ extends an inward distance from the interior wall such that sections of the continuous seals 102s1 and 102s2 resting in the continuous seal grooves 120′, will be brought into sealing contact with a first diameter portion 122 that forms a well in the rotor. With this single seal arrangement, first and second chambers formed within the first diameter portion 122 are separated only by the single seal 102s1. Similarly, the third and fourth chambers are formed with the other first diameter portion (not visible in FIG. 4) and are also separated only by the single seal 102s2.

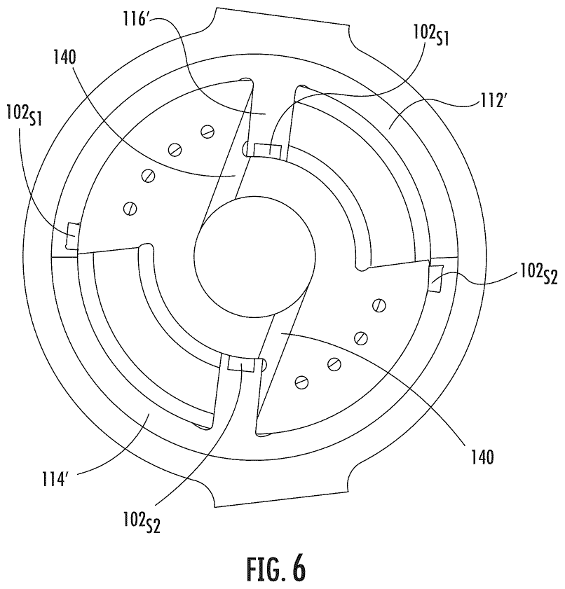

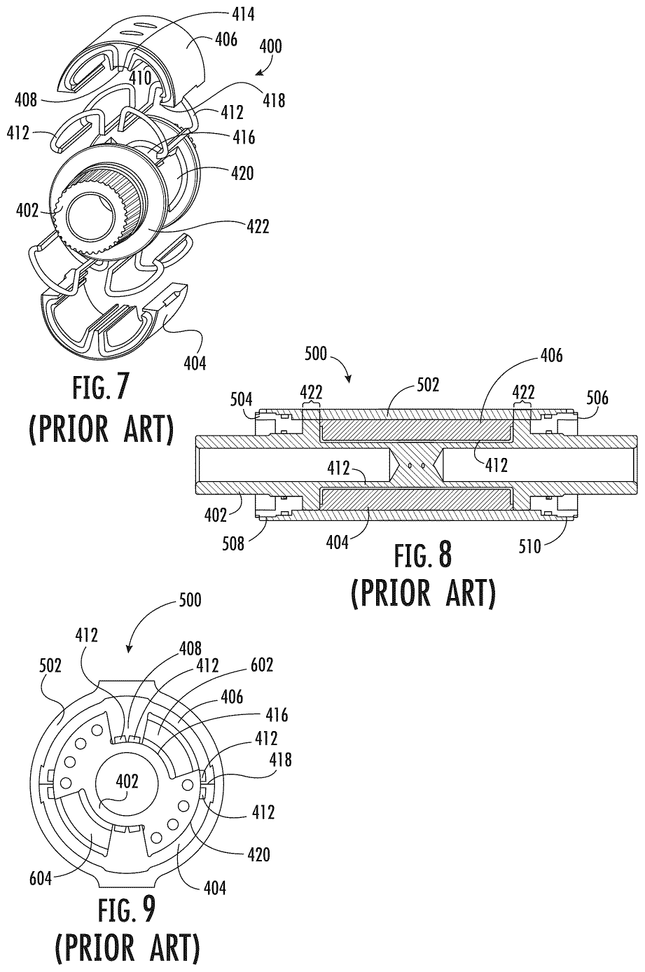

The first and fourth chambers are each sealed by the continuous seals 102s1 and 102s2 and connected by a connecting passage therebetween through the rotor (not visible in FIG. 4 but shown in FIG. 6 at 140). The second and third chambers are not sealed by a continuous seal as is the case with the embodiment shown in FIG. 1. Instead, in this flooded embodiment, fluid communication between these second and third chambers occurs along the outer radial surface 108′ and as may be seen in FIG. 5, is limited by the bearings 136, retainers 138, radial static seals 130, and the radial dynamic seals 132, 134. Further, the continuous seals 102s1 and 102s2 prevent any fluid communication from the second and third chamber to the first and fourth chamber.

While the embodiments discussed above utilize two wells on opposite sides of the rotor, forming with the continuous seals and in an embodiment other seals four chambers, those skilled in the art will recognize from the foregoing that other embodiments may include only one well and the two chambers formed therein by the seals. Further, those skilled in the art will recognize from the foregoing that other embodiments may include more than two wells, each divided into two chambers by the seals discussed above, positioned around the rotor, preferably at equidistant locations around the rotor, e.g. two wells centered 180° apart, three wells centered 120° apart, four wells centered 90° apart, etc. to provide equal force about the rotor to cause rotation thereof. However, in other embodiments, the location of the wells is not so limited to equidistant locations.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A rotary actuator, comprising:
a rotor having a first diameter portion forming a well within a second diameter portion;
a static rotary piston having an inner vane extending an inward radial distance from an interior wall that extends into the well formed by the first diameter portion of the rotor, the static rotary piston defining a seal groove that runs along a peripheral face of the inner vane and lateral and longitudinal ends of the interior surface of the static rotary piston;
a continuous seal configured to seat in the seal groove; and
wherein the continuous seal is in sealing contact with the rotor such that the continuous seal forms a vane seal transition from a face seal located at the inner vane surface perpendicular to a rotary axis of the rotor to a radial seal located at the lateral end of the interior wall of the static rotary piston in parallel with the rotary axis of the rotor thereby dividing the well into a first and a second pressure chamber; and
wherein the continuous seal is configured as a dynamic seal to prevent leakage between the first and second pressure chambers.

2. The rotary actuator of claim 1, wherein the static rotary piston comprises a first static rotary piston and a second static rotary piston each formed as a half-cylinder shell.

3. The rotary actuator of claim 2, wherein the rotor has two of the first diameter portions, and wherein the well formed within the second diameter portion includes a first and a second well formed opposite one another within the second diameter portion, and wherein the first static rotary piston and the second static rotary piston each have an associated inner vane extending an associated inward radial distance from an associated interior wall that extends into an associated well of the rotor, and wherein each of the first static rotary piston and the second static rotary piston has an associated continuous seal in sealing contact with the rotor such that each of the associated continuous seals form an associated vane seal transition from an associated face seal located at an associated inner vane surface perpendicular to the rotary axis of the rotor to an associated radial seal located at an associated lateral end of an associated interior wall of each of the associated static rotary piston in parallel with the rotary axis of the rotor thereby dividing the first well into a first and a second pressure chamber and the second well into a third and fourth pressure chamber.

4. The rotary actuator of claim 3, wherein the second pressure chamber and the third pressure chamber are in fluid communication to rotate the rotor in a first direction when fluid pressure is supplied thereto, and wherein the first pressure chamber and the fourth pressure chamber are in fluid communication to rotate the rotor in a second direction when fluid pressure is supplied thereto.

5. A rotary actuator, comprising:
a rotor having a first diameter portion forming a well within a second diameter portion;
a static rotary piston having an inner vane extending an inward radial distance from an interior wall that extends into the well formed by the first diameter portion of the rotor, the static rotary piston defining a seal groove that runs along a peripheral face of the inner vane and lateral and longitudinal ends of the interior surface of the static rotary piston;
a continuous seal configured to seat in the seal groove; and
wherein the continuous seal is in sealing contact with the rotor such that the continuous seal forms a vane seal transition from a face seal located at the inner vane surface perpendicular to a rotary axis of the rotor to a radial seal located at the lateral end of the interior wall of the static rotary piston in parallel with the rotary axis of the rotor thereby dividing the well into a first and a second pressure chamber;
wherein the continuous seal is configured as a dynamic seal to prevent leakage between the first and second pressure chambers;
wherein the static rotary piston comprises a first static rotary piston and a second static rotary piston each formed as a half-cylinder shell;
wherein the rotor has two of the first diameter portions, and wherein the well formed within the second diameter portion includes a first and a second well formed opposite one another within the second diameter portion, and wherein the first static rotary piston and the second static rotary piston each have an associated inner vane extending an associated inward radial distance from an associated interior wall that extends into an associated well of the rotor, and wherein each of the first static rotary piston and the second static rotary piston has an associated continuous seal in sealing contact with the rotor such that each of the associated continuous seals form an associated vane seal transition from an associated face seal located at an associated inner vane surface perpendicular to the rotary axis of the rotor to an associated radial seal located at an associated lateral end of an associated interior wall of each of the associated static rotary piston in parallel with the rotary axis of the rotor thereby dividing the first well into a first and a second pressure chamber and the second well into a third and fourth pressure chamber;
wherein the second pressure chamber and the third pressure chamber are in fluid communication to rotate the rotor in a first direction when fluid pressure is supplied thereto, and wherein the first pressure chamber and the fourth pressure chamber are in fluid communication to rotate the rotor in a second direction when fluid pressure is supplied thereto; and
wherein the first pressure chamber and the fourth pressure chamber are in fluid communication via a connecting passage through the rotor, and wherein the second pressure chamber and the third pressure chamber are in fluid communication via an exterior of the rotor.

6. The rotary actuator of claim 1, wherein the seal groove comprises a first seal groove that runs along a peripheral face of the inner vane and along a first half of the lateral and the longitudinal ends of the interior surface of the static rotary piston, and a second seal groove that runs along the peripheral face of the inner vane and along a second half of the lateral and the longitudinal ends of the interior surface of the static rotary piston, and wherein the continuous seal comprises a first continuous seal configured to seat in the first seal groove and a second continuous seal configured to seat in the second seal groove.

7. The rotary actuator of claim 1, wherein the radial seal of the vane seal transition does not include an interior seal gland wall.

8. The rotary actuator of claim 1, wherein the continuous seal fluidly isolates the first pressure chamber from the second pressure chamber.

9. The rotary actuator of claim 8, wherein the rotor is fluidly sealed within a housing by dynamic seals, static seals and positioned therein by bearings and retainers, and wherein the second pressure chamber is in fluid communication with an exterior of the rotor and sealingly isolated by the dynamic seals, static seals, bearings, and retainers.

10. The rotary actuator of claim 1, wherein the static rotary piston comprises a first static rotary piston, a second static rotary piston, and a third static rotary piston, and wherein the rotor has three first diameter portions forming a first, a second, and a third well formed about the rotor within the second diameter portion thereof, and wherein the first static rotary piston, the second static rotary piston, and the third static rotary piston each have an inner vane extending an inward radial distance from an interior wall that extends into an associated well of the rotor, and wherein each of the first static rotary piston, the second static rotary piston, and the third static rotary piston have a continuous seal in sealing contact with the rotor such that each of the continuous seals form a vane seal transition from the face seal located at the inner vane surface perpendicular to the rotary axis of the rotor to the radial seal located at the lateral end of the interior wall of the static rotary piston in parallel with the rotary axis of the rotor thereby dividing the first well into a first and a second pressure chamber, the second well into a third and fourth pressure chamber, and the third well into a fifth and sixth pressure chamber.
